(19) United States
(12) Patent Application Publication
(10) Pub. No.: US 2006/0281552 A1
(43) Pub. Date: Dec. 14, 2006

(54) Method and apparatus for participating in a live event

(76) Inventor: Kishan Bulusu, Morgan Hill, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/274,783

(22) Filed: Nov. 14, 2005

(30) Foreign Application Priority Data
May 26, 2005 (IN) 634/CHE/2005

(51) Int. Cl. G06F 19/00

(52) U.S. Cl. 463/41

(57) ABSTRACT

A game can allow a player to participate in a live event as if the player were one of the participants. In one embodiment, the present invention includes capturing information about a live event and generating a game based on the captured information. The game can than be provided to, via an interface to a mobile client device. The user of the mobile client device can play the game by creating user input, which can be received by a game server from the mobile client device via the interface. The user input than can be used to virtually perform an action in the game, and the result in the game can then be compared with the result in the live event.

### CLAIM OF PRIORITY

This application claims the priority benefit of Indian Provisional Patent Application No. 634/CHE/2005, filed with the Government of India, Patent Office Branch on May 26, 2005, and entitled “Method of Immersive Gaming”.

### BACKGROUND

1. Field

Embodiments of the present invention relate generally to the field of computer gaming. More particularly, embodiments of the present invention relate to combining computer gaming with a real live event.

2. Description of the Related Art

Internet, television (TV) and mobile platforms have become indispensable to consumers and businesses. Gaming software and platforms enable gamers to play various games, which are modeled on virtual and real life environments. By providing information, broadcasting events, communicate easily and enabling users to interact with each other, they have enabled users to become mobile, increase productivity and get entertained in new ways.

However, the users are still limited to a passive role. They can watch an event live at the place of the event or watch it on the TV. They can also follow the latest updates on the Internet or hear it on other media. Some level of interactivity is presented to the user through fantasy games or predictive contests around the event. Games on various devices offer a higher level of interaction, though they are not directly related to the real event as it is happening. What is needed is a comprehensive system to enable a user to more actively participate in an event of the user's interest as it is happening, taking the user closer to and into the event.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating one configuration of a client device connected to the server over the network;

FIG. 2 is a block diagram illustrating one configuration of a live participative gaming according to one embodiment of the present invention.

FIG. 3 is a block diagram illustrating the live participative gaming with a connected client device;

FIG. 4 is a block diagram illustrating one configuration of the capture system according to one embodiment of the present invention;

FIG. 5 is a block diagram illustrating one configuration of a data processing system according to one embodiment of the present invention;

FIG. 6 is a block diagram illustrating the use of the processed data according to one embodiment of the present invention;

FIG. 7 is a block diagram illustrating the way a user can participate in an event or game according to one embodiment of the present invention;

FIG. 8 is a block diagram illustrating the way a user can select the participative roles according to one embodiment of the present invention;

FIG. 9 is a block diagram illustrating the live participative gaming according to one embodiment of the present invention; and

FIG. 10 is a block diagram illustrating the participation feedback mechanism for the user according to one embodiment of the present invention.

### DETAILED DESCRIPTION

Although the present system will be discussed with reference to various illustrated examples, these examples should not be read to limit the broader spirit and scope of the present invention. Some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated.

The terms ‘user’, ‘player’ and ‘participant’ are used interchangeably herein to refer to the actual person who uses the software. The ‘user’ could be a person or could be automated software or other programs.

The terms ‘game’ or ‘event’ are used interchangeably to mean any sporting game, news event, historical event, personal event or happening, etc.

The terms ‘client device’, ‘mobile device’, ‘device’, ‘Personal Computer’, ‘computer’, ‘laptop’ and ‘cell phone’ are used interchangeably to refer to the actual device used by the participant to access the virtual reality world for the immersive experience. Each computer or computer server might be a multipurpose or a special purpose computer of varying size or transactional capacity. Each device might be a multipurpose or a special purpose device of varying size or transactional capacity. As used herein, the terms ‘computer’, ‘user computer’ and ‘device’ are intended to cover any multi-purpose computer, handheld device, game console, cell phone, PDA, laptop or any other device that permits a user to connect to, capture the game or event and communicate with the participative game or event of the present invention. Each device used to connect a player to the participative game or event may be considered as a ‘client’. The server could be the client device too, where it can act as a client and a server.

The terms ‘internet’, ‘telecommunication network’, ‘network’ and ‘wireless network’ are used interchangeably to mean the means of connecting a device to the game server or with other devices to participate in the game or event.

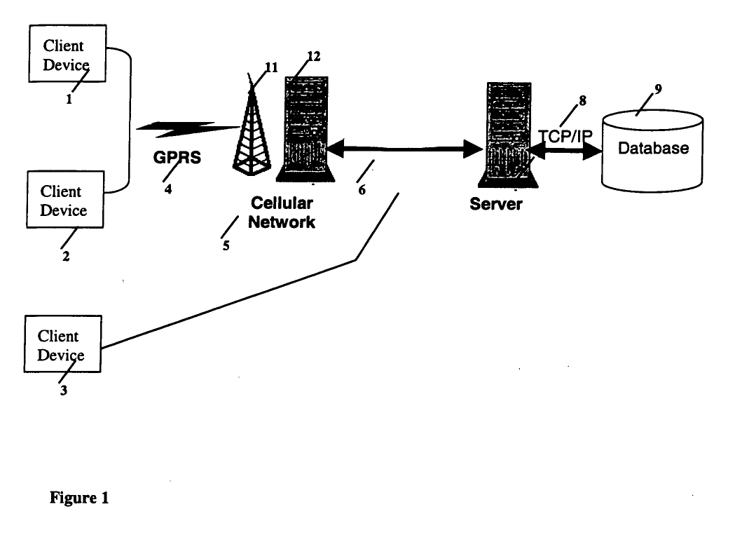

FIG. 1 illustrates a simple prior art configuration of a client device connected to the server over the internet. Client Devices 1,2 connect to the Cellular Network 5 using GPRS 4. The Cellular network 5 connects to the Server 7 through the Internet 6. The Client Device 3 connects to the Server through the Internet 6. The Server 7 connects to the database 9 using TCP/IP 8 protocol. The cellular network illustrated consists of one gateway 12 and one cell tower 11.

The Cellular Network 16 could be much more complex than the simplified diagram in FIG. 1. There could be multiple cellular gateways and cell towers making up the cellular network 5. There could be multiple networks within a network and these could be interconnected in several ways. There could also be multiple clients connecting to the Server through the Cellular Gateway or to the Internet. And the clients could connect directly or indirectly with each other and to the server through various protocols including Bluetooth or GSM or CDMA or TCP/IP or by any other means. A simple configuration with 3 Clients 1, 2, 3 connected is shown here. Client devices 1 and 2 could be any cellular devices. Client device 2 could be any device that connects to the Internet like a Personal Computer, Laptop or IP Enabled TV. These could connect directly or through some other network device to the Internet. The devices could also connect directly to the server. The network could be any network including a LAN network, WiFi network, Peer to Peer network or other mechanisms of connecting and transmitting data and voice. The connection protocols could any protocols including TCP/IP or Peer-to-Peer or 802.11g or GSM or CDMA.

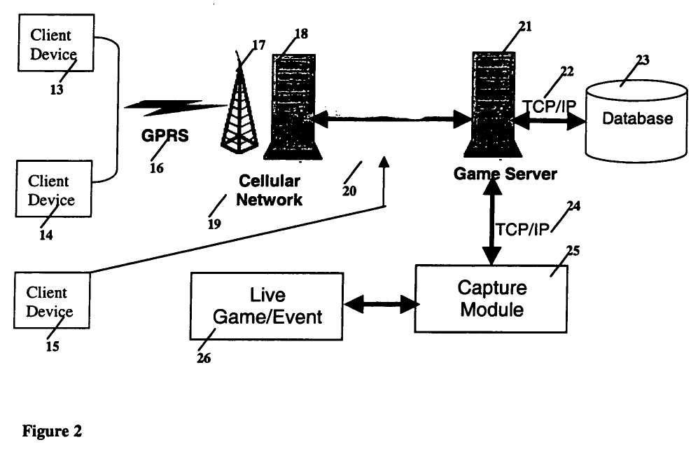

One embodiment of the invention is now illustrated with reference to FIG. 2. FIG. 2 shows the same simplified configuration of a client device connecting to the server through the Internet. However, the Game Server 21 module is on the server and it is connected to the Game Capture Module 25. The Game Capture Module 25 interacts with the Live Game/Event 26 to capture the live event data, which is used for creating the participative gaming.

The capture module 25 captures the live game or event 26. The captured data is then processed by the game server module 21 into the play scenarios needed for game play, by the application of rules and other logic required for the game play. The Game Server Module 21 also manages the game play and related rules to make game or event participation.

The user is then able to play the games from the client device 13 using either the Client Module installed on the device or through the device Internet browser. The client module on the client device 13 will be provided with the game data and other details from the Game Server Module 11.

The client module on the client device 13 will be the interface between the user and the game server 21. The module will take the data from the server and present it to the user. The user actions and related data would then be processed and sent to the game server by the client module.

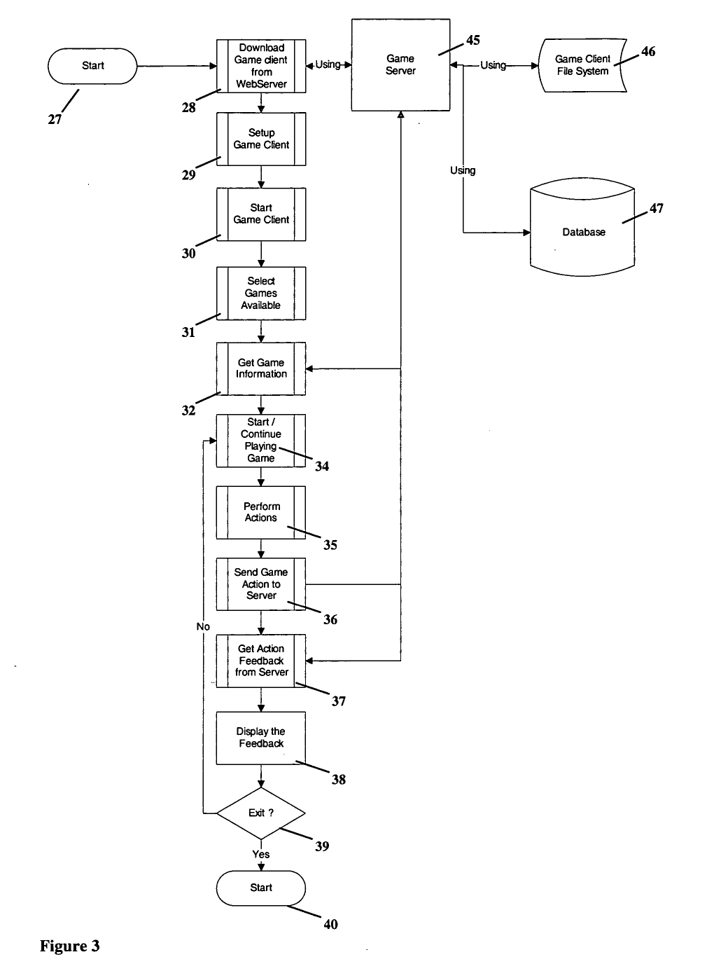

One embodiment of the game client is illustrated in FIG. 3. The user downloads the game client from the server 28. The Game Server 45, the Game Client File System 46 and the Database 47 facilitate the download process and maintenance of the client by the user. The game client is then installed on the user device 29 and the user starts the game client 30. The user then selects a game from the games available 31, gets the game information 32 from the game server and starts playing the game 34. The user performs game actions 35, which are sent to the server 36 by the game client. The game action feedback from the server 37 is presented to the user as feedback 38 on the users performance in the game play scenario. The user can then continue to play or Exit 39.

One embodiment of the invention is to enable the casting of the game or event using the Game Capture module. The casting could be of a live game or an archived game or an imaginary game. The user captures the data using the Game Capture Module 25 and the data is sent to the Game Server Module 21, which then casts the data to the users. The data could be in an animation format or a mixture of animation, images and video.

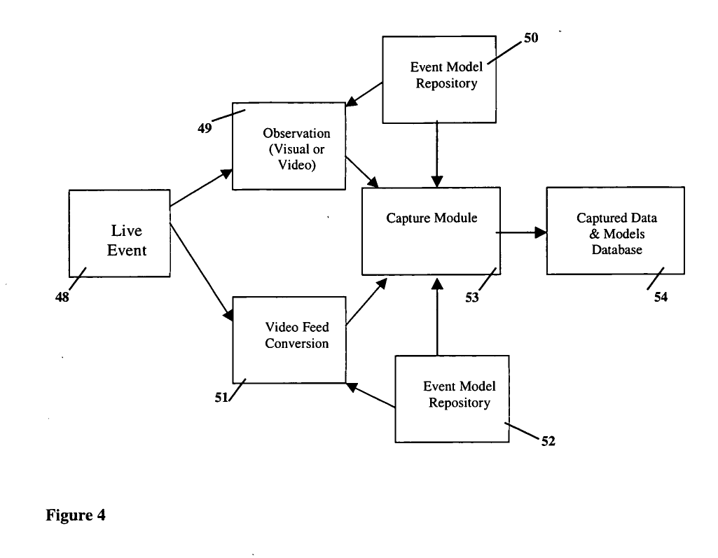

One embodiment of the data capture of the event or game is illustrated in FIG. 4. In this illustration the process for the capture of the event or game is provided. As the game or event is happening 48, it can be captured in a number of ways. One way to capture the event is observation 49, where the live event or play information is entered manually into a capture module 53 for further processing and game play, to apply any relevant event information from the Event Model Repository 50.

Another way to capture the event is Video Feed Conversion 51, where the video from the event or the play is streamed into the capture module 53, which will then process it further to enable game play using any relevant information from the Event Model Repository 52. The capture module 25 collects the information from either or both the above methods into the Captured Data & Models Database 53. The use of the event model repository databases can be while the event is being captured or also after the event data has been collected.

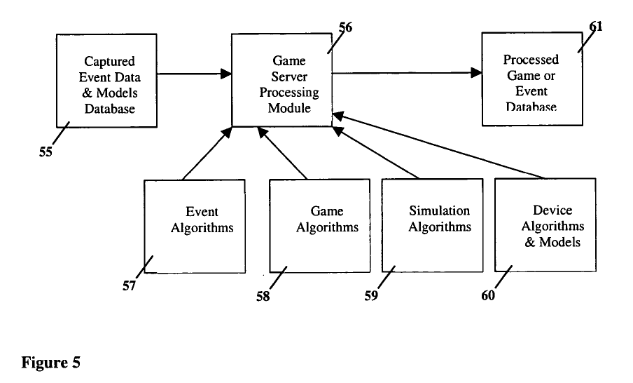

One embodiment of the data processing is illustrated in FIG. 5, where the Captured Event Data and Models Database 55 for the event are submitted for processing to the Game Server Processing Module 56. The game server then processes the data by the applications of various rules and algorithms to enable the data and the models to be used for game play.

These rules and algorithms could be applied sequentially or in parallel, depending on the scenarios of the games or events. One flow could be that the Event Algorithms 57 is applied. These could include, based on the kind of event or game, the physical characteristics like the stadium settings, the audience patterns, etc.

Then Game Algorithms 58 is applied which could include the physics of the movements like the ball flights, the rules of the game or event, etc. The Simulation Algorithms 59 could include the path of the ball or the simulation of the hit by the player, etc. The Device Algorithms 60 could include the specific rules that need to be applied to make the game or event available for playing on various devices, etc. like mobile phones, PC's, PDA's, Digital TV's, etc. After processing the data, the game server-processing module 56 converts the captured data and models database to the Processed Game or Event Database 61.

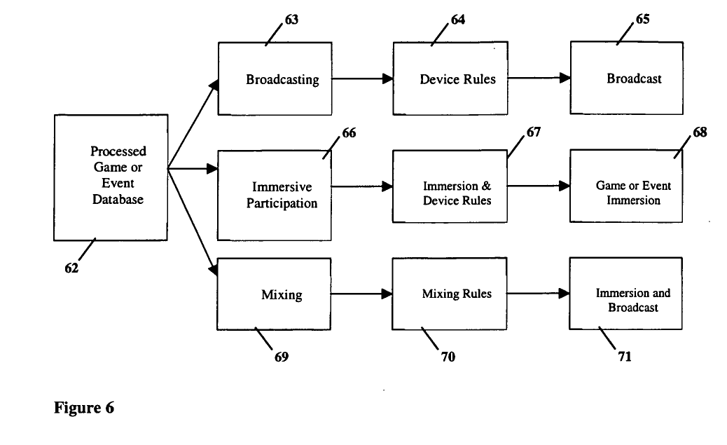

One embodiment of the process of using the processed data to create various participative experiences for the user are illustrated in FIG. 6. The processed game data is then used for either Broadcasting 63 for the purposes of only viewing interactively or for Immersive Participation 66 in the game around the live event or sport. Also, it could be used for the purposes of Mixing 69 both the above elements to provide the user a game play and a broadcasting experience.

Various rules and algorithms could be applied in preparing the data for the purposed of broadcasting or game play or mixing, based on the need for the particular game or event. For Broadcasting 63, Device Rules 64 related to the device configurations are applied and processed to present the user with a broadcasting experience. For Immersive Participation 66 Immersion & Device Rules 67 are applied and presented to the user for Game or Event Immersion 68 experience. For Mixing 69 Mixing Algorithms 70 are applied to provide the user with a Immersion and Broadcast 71 experience.

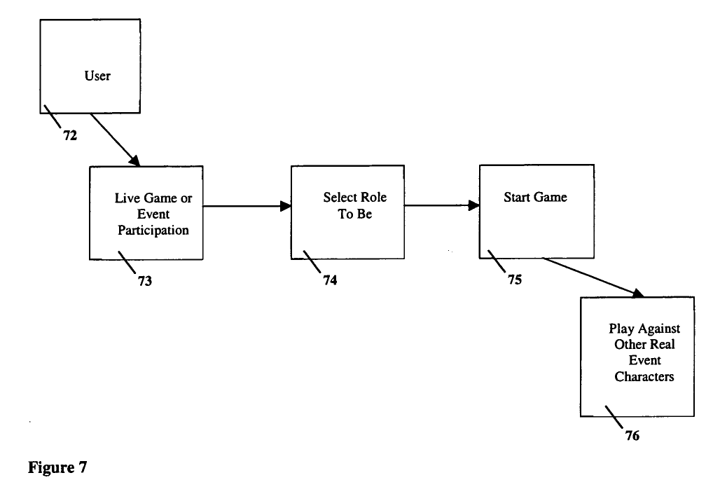

One embodiment of the live participative gaming is illustrated in FIG. 7. In this scenario, if there is a live sporting event like a football game between 2 teams happening, the user can take part in the game as one of the participant. The user 72 selects the live game or event to participate in 73 from the list of available events. The user then selects the role to adopt 74 or Avatar that the user would like to play as. User then starts game 75 as the avatar and can play against other real event characters 76 live, as if the user is participating in the real event or game.

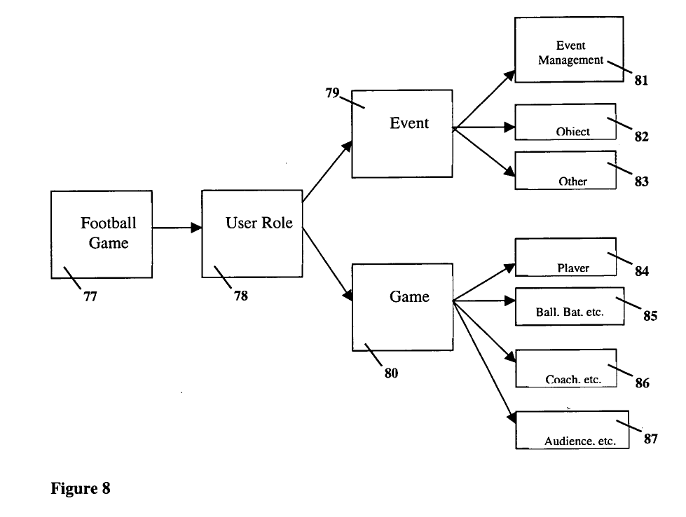

One embodiment of the process of selecting the participative roles or avatars is illustrated in FIG. 8. In this scenario of a football game 77, the user uses his or her device to connect to playing the game. The user is presented with the option to choose the user role 78 that he or she would like to assume. The user then may assume the avatar of, for example, the ‘offensive quarterback’, in the game 80.

The user is then given control of the offensive quarterback avatar in the game. All the needed game scenarios and the action on the football field, as they are happening, for the game are presented to the user, except for the avatar the user assumed. So, in this example, the user is presented with the football and has to make the same or similar or better plays as the live quarterback player in the actual game. The actions of the rest of his team and the defensive team would be rendered to the user.

The user is not limited to participative role in the game and might take multiple roles. For instance, the user could adopt the offensive quarterback role to start with. When the ball is thrown to a receiver by the quarterback, the user might become the receiver and play as if he is playing the live game receiver's role.

At the end of the play, at frequent intervals and at the end of the game, the user is presented with a participative scorecard of how his or her performance compares to the live player or players. The user may also exit from the game and come back to re-join the game, with an option to either continue from where the user left the game or from the live scenario at the point of re-joining.

The user may also select an Event 79 role, like being a Event Manager 81. As an event manager, the user will manage the event or related Objects 82 or other 83 roles of the Football game event.

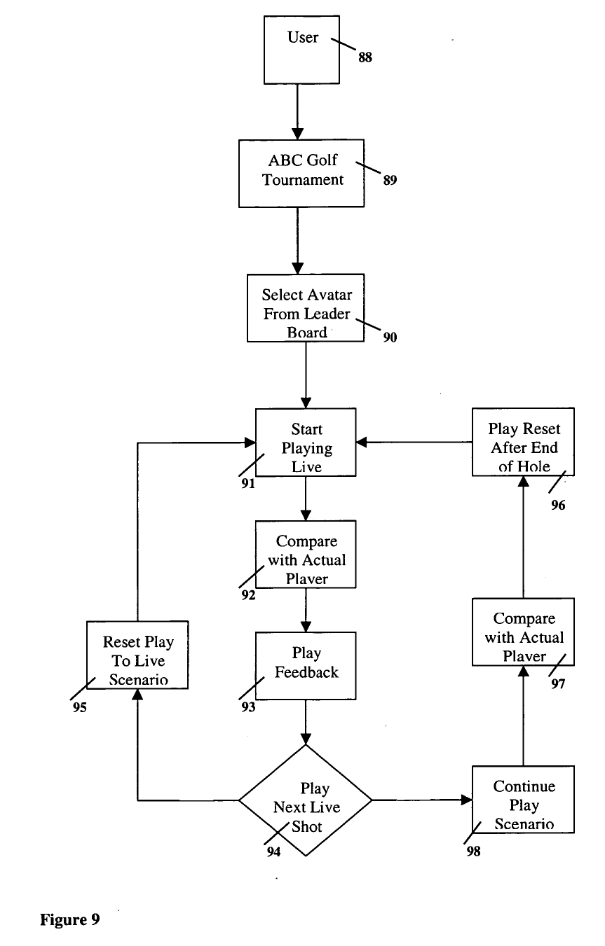

One embodiment of the live participative gaming in a live golf game is illustrated in FIG. 9. The user 88 is participating in an ABC major golf tournament 89 and uses his or her device to connect to the game server that will enable him to play the game, as the golf tournament is happening.

The user is presented with the current scenario of the ABC major golf tournament and the option of choose the avatar he or she wants to assume. An avatar is an instance of the real player playing the golf tournament, at that particular point of time. User can select the avatar from the leader board 90 and start playing the tournament live 91.

All the user actions and the performance would be compared with the actual live player 92 whose avatar the user has assumed and the user's performance would be judged against the actual player's performance.

For instance, on the first hole, the actual player selects the driver for his tee shot and plays the shot towards the right of the fairway with a hit clearing a distance of 265 yards. The user, who assumed the player's avatar, plays the same hole on the user device and uses the driver to hit 240 yards to the left of the fairway.

In this instance, the user has not exactly matched the real player, whose avatar he or she had assumed. The user would be provided the play feedback 93, based on his or her performance against the live player.

The comparison with the actual player and feedback may not be limited to the examples in this illustration. They might include all the different direct and indirect variables of the game.

In this instance, the user may not be awarded points for not exactly matching the real player's actions in the game. The game points schemes would be developed according to the game and the game scenarios for performance rating.

For the second shot, the user is given the option to play the next live shot 94, which is the shot that the actual live player will make from the point where the player's first shot landed at the 265 yards distance. If the user selects this scenario, the reset play to live scenario 95 is presented and the user can continue to play the next shot live 91. The game scenario as described above would be repeated for each of the shot played by the player and the participant, until the live golf game ends or the user chooses to exit the game.

In the play next live shot 94, if the user selects not to play the live shot and continue the current play scenario 98, he or she can continue the game from the first shot and the performance is compared to the live player after the end of the first hole 97. So, the user will play the golf ball from the 240 yards mark, where the user's first shot had landed. Then Play is reset after the end of the hole 96 and the user can continue to play live from the next hole.

The participative gaming is not limited to one user. There could be multiple users adopting the avatars of different players playing the game or multiple users adopting the avatars of the same player. The participative gaming module and the game server module will then compare each of the participative users to their avatars and would also rank them against each other. The ranking may be based on various rules depending on the game and the game scenarios.

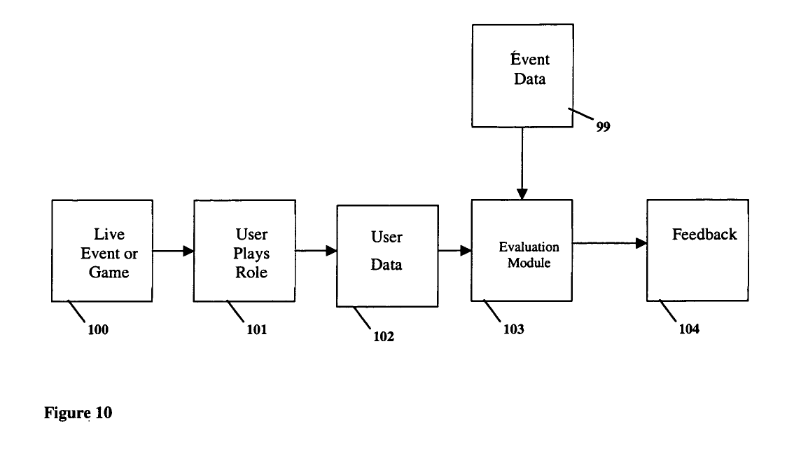

One embodiment of the current invention is illustrated in FIG. 10 providing a tracking and feedback mechanism to the users in a live game. As the live event or game 100 is happening and the user plays the selected role 101, the participative game server's evaluation module 103 takes the event data 99 and the user data 102 to provide feedback 104 to the user. The feedback may be provided live as the game is happening and as the user plays the game. Or it could also be provided at the end of the game.

Thus, a participative gaming system has been described. In the forgoing description, various specific values were given names, such as “Golf,” and various specific modules, such as the “game server module” and “event model database” have been described. However, these names are merely to describe and illustrate various aspects of the present invention, and in no way limit the scope of the present invention. Furthermore, various modules, such as the capture module 25 in FIG. 2 and the client module described in above can be implemented as software or hardware modules, or without dividing their functionalities into modules at all. The present invention is not limited to any modular architecture either in software or in hardware, whether described above or not.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Embodiments of the present invention may be provided as a computer program product that may include a machine-readable medium having stored thereon instructions, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method performed by a gaming server, the method comprising:
capturing information about a live event;
providing the captured information to a client device to be used by the client device to provide a game for a user of the client device;
receiving a result associated with the game being played by the user from the client device; and
comparing the result received from the client device to a corresponding result in the live event.

2. The method of claim 1, wherein the client device comprises a mobile client device.

3. The method of claim 2, wherein capturing information about the live event comprises receiving a video feed of the live event and extracting the information about the live event from the video feed.

4. The method of claim 2, wherein the live event comprises a sporting event.

5. The method of claim 2, wherein the received result comprises a result of an action performed by an avatar corresponding to a participant in the real event, wherein the participant performed a corresponding action in the live event having the corresponding result.

6. A method performed by a mobile client device, the method comprising:
receiving a game from a game server, the game being a representation of a live event;
providing an interface to a user to allow a user to play the game as a participant in the live event; and
providing user input from the user interface to the game server for comparison to the live event.

7. The method of claim 6, wherein providing the interface comprises providing an interface to select an avatar representing the participant in the live event.

8. The method of claim 6, further comprising receiving an evaluation from the game server based on the comparison.

9. The method of claim 6, wherein the live event comprises a sporting event.

10. A method performed by a gaming server, the method comprising:
capturing information about a live event;
generating a game based on the captured information;
providing an interface to the game to a mobile client device;
receiving user input from the mobile client device via the interface;
performing an action in the game based on the received user input; and
comparing a result of the action to a corresponding result in the live event.

11. The method of claim 10, wherein the live event comprises a sporting event.

12. The method of claim 10, wherein providing the interface comprises providing an interface to allow a user of the mobile client device to select a participant of the live event and to control a representation of the participant via the user input.

13. The method of claim 12, wherein performing the action in the game comprises performing an action by the representation of the participant in the game, and comparing the result comprises comparing the result of the action by the representation of the participant in the game with a corresponding action by the participant in the game.

14. A machine-readable medium having stored thereon data representing instructions that, when executed by a processor, cause the processor to perform operations comprising:
receiving a game from a game server, the game being a representation of a live event;
providing an interface to a user to allow a user to play the game as a participant in the live event; and
providing user input from the user interface to the game server for comparison to the live event.

15. The machine-readable medium of claim 14, wherein providing the interface comprises providing an interface to select an avatar representing the participant in the live event.

16. The machine-readable medium of claim 14, wherein the instructions further cause the processor to receive an evaluation from the game server based on the comparison.

17. The machine-readable medium of claim 14, wherein the live event comprises a sporting event.

18. A machine-readable medium having stored thereon data representing instructions that, when executed by a processor, cause the processor to perform operations comprising:
capturing information about a live event;
generating a game based on the captured information;
providing an interface to the game to a mobile client device;
receiving user input from the mobile client device via the interface;
performing an action in the game based on the received user input; and
comparing a result of the action to a corresponding result in the live event.

19. The machine-readable medium of claim 18, wherein the live event comprises a sporting event.

20. The machine-readable medium of claim 18, wherein providing the interface comprises providing an interface to allow a user of the mobile client device to select a participant of the live event and to control a representation of the participant via the user input.

21. The machine-readable medium of claim 20, wherein performing the action in the game comprises performing an action by the representation of the participant in the game, and comparing the result comprises comparing the result of the action by the representation of the participant in the game with a corresponding action by the participant in the game.
